(19) United States
(12) Patent Application Publication
(10) Pub. No.: US 2004/0218397 A1
(43) Pub. Date: Nov. 4, 2004

(54) Wheel cover with self generating light arrangement

(76) Inventor: Xing Wen Luo, San Gabriel, CA (US)

Correspondence Address: Raymond Y. Chan, Suite 128, 108 N. Ynez Ave., Monterey Park, CA, 91754, US

(21) Appl. No.: 10/677,892

(22) Filed: Oct. 3, 2003

Related U.S. Application Data
(60) Provisional application No. 60/466,683, filed on Apr. 29, 2003.

(51) Int. Cl. B60Q 1/00

(52) U.S. Cl. 362/500

(57) ABSTRACT

A wheel cover includes a cover body having an outer side, an opposed inner side, a holding slot formed on the cover body to communicate the outer side with the inner side, and a plurality of attaching arms extended from the inner side of the cover body for detachably attaching the cover body on the wheel. A self generating light arrangement includes a power generating unit coaxially mounted on the inner side of the cover body, wherein the power generating unit is adapted for self-generating electricity by means of induction when the cover body is rotated with respect to the wheel, and at least an illuminating unit, which is electrically connected with the power generating unit, securely mounted at the holding slot of the cover body in such a manner that when the cover body is driven to rotate, the illuminating unit is activated for providing a light effect.

### CROSS REFERENCE OF RELATED APPLICATION

This is a Regular Application of a provisional application, application No. 60/466,683, filed Apr. 29, 2003.

### BACKGROUND OF THE PRESENT INVENTION

1. Field of Invention

The present invention relates to a wheel cover, and particularly to a wheel cover with a self generating light arrangement, wherein the wheel cover is adapted for mounting on a wheel such that the self generating light arrangement is capable of generating a light effect by the rotational movement of the wheel.

2. Description of Related Arts

Generally, there are three common types of wheel cover incorporated with a lighting arrangement which are capable of producing a light effect, namely battery type, dynamo type and car battery source type.

A battery type wheel cover makes use of a battery or cell to produce electrically and light effect such that the wheel cover is capable of incorporating with any wheel without any internal battery such as bicycle. A dynamo type wheel cover makes use of the dynamo as the electricity source. A car battery source type wheel cover uses the energy transmitted from car battery. However, all these three wheel covers have substantial drawbacks.

Since the battery type wheel cover makes use of a battery or cell as an external source of energy, the light effect will stop once the battery or cell is being exhausted. Therefore, the battery or cell is required to replace frequently. In other words, it is a hassle that the operation requires the user to detach the wheel cover from the wheel in order to replace the battery. Moreover, a centrifugal switch is usually used for controlling the lighting arrangement in an on and off manner such that the light effect may not be desirable when the vehicle is moving under various acceleration. Thus, it is troublesome and inconsistent to produce the light effect.

The dynamo type wheel cover uses the energy produced from the dynamo which produces electricity from the relative motion of the dynamo and the vehicle so as to trigger the lighting arrangement to produce the light effect. However, due to the complicated circuit design of the lighting arrangement, the installation and maintenance of such dynamo wheel cover is not easy and so is totally not user friendly. Thus, it is not a good device for generating light effect and it is not desirable to use as a lighting wheel cover.

The car battery source type wheel cover utilizes the car battery of the vehicle. However, the connecting means of the lighting arrangement requires providing a stable power supply from the car battery to the lighting arrangement of the wheel cover. Since the wheel is moving in a rotatable manner, and maybe under varied discrete speed or different conditions, the connectivity may not be stable and constant if the connecting means make use of electric wires. On the other hand, if a more reliable connecting means, such as an electric plug installed in the axle of the wheel, is used, a car-owner generally cannot assemble the lighting arrangement by himself and it is quite a complex method for installing the car battery source type wheel cover. In addition, the vehicle without battery as one of its components, such as bicycle, cannot employ with such car battery source type wheel cover. In other words, the car battery source type wheel cover is limited to be utilized for the vehicle having the battery.

Despite the above disadvantages of the existing wheel covers, the problem will be more serious if the environmental condition is not good, as in a sandy or dirty environment. The sand, dust, or dirt may render the connecting means or the dynamo ineffective and totally broke down the lighting arrangement eventually.

In view of above, the existing methods are either complex or unreliable, thus it is necessary to introduce a more user friendly and reliable method for the general car owners.

### SUMMARY OF THE PRESENT INVENTION

A main object of the present invention is to provide a wheel cover with a self generating light arrangement, wherein the wheel cover is adapted for mounting on a wheel such that the self generating light arrangement is capable of generating a light effect by the rotational movement of the wheel.

Another object of the present invention is to provide a wheel cover with a self generating light arrangement which comprises a power generator mounted at the wheel cover to directly transform the kinetic energy of the wheel so as to produce power for generating the light effect.

Another object of the present invention is to provide a wheel cover with a self generating light arrangement which is easy to install and is universal to wheels of different vehicles or transportation means, such as car, motorbike or bicycle.

Another object of the present invention is to provide a wheel cover with a self generating light arrangement, wherein the power generator is powered by the kinetic energy of the wheel to generate electricity so that no extra energy source is required for the self generating light arrangement, which is environmental friendly.

Another object of the present invention is to provide a wheel cover with a self generating light arrangement which is simple but reliable, wherein the use of connecting wires or installation of complex electric device are minimized so as to reduce the works for maintenance for the self generating light arrangement.

Another object of the present invention is to provide a wheel cover with a self generating light arrangement, wherein no expensive or complicated structure is required to employ in the present invention in order to achieve the above mentioned objects. Therefore, the present invention successfully provides an economic and efficient solution for providing the decorative light effect for the vehicle without altering the original structure thereof.

Accordingly, in order to accomplish the above objects, the present invention provides a wheel cover adapted for mounting on a wheel, comprising:

a cover body having an outer side, an opposed inner side defining a receiving cavity, at least a holding slot formed on the cover body to communicate the outer side with the inner side, and a plurality of attaching arms extended from the inner side of the cover body for detachably attaching the cover body on the wheel; and

a self generating light arrangement, comprising:

a power generating unit coaxially mounted on the inner side of the cover body within the receiving cavity, wherein the power generating unit is adapted for self-generating electricity by means of induction when the cover body is rotated with respect to the wheel; and

at least an illuminating unit, which is electrically connected with the power generating unit, securely mounted at the holding slot of the cover body in such a manner that when the cover body is driven to rotate, the illuminating unit is activated for providing a light effect.

These and other objectives, features, and advantages of the present invention will become apparent from the following detailed description, the accompanying drawings, and the appended claims.

### BRIEF DESCRIPTION OF THE DRAWINGS

FIG. 1A is a front view of a wheel cover with a self generating light arrangement according to a preferred embodiment of the present invention.

FIG. 1B is a side view of the wheel cover with the self generating light arrangement according to the above preferred embodiment of the present invention.

FIG. 1C is a rear view of the wheel cover with the self generating light arrangement according to the above preferred embodiment of the present invention.

FIG. 2 is an exploded perspective view of the wheel cover with the self generating light arrangement according to the above preferred embodiment of the present invention.

FIG. 3 is an exploded perspective view of the power generator of the wheel cover with the self generating light arrangement according to the above preferred embodiment of the present invention.

### DETAILED DESCRIPTION OF THE PREFERRED EMBODIMENT

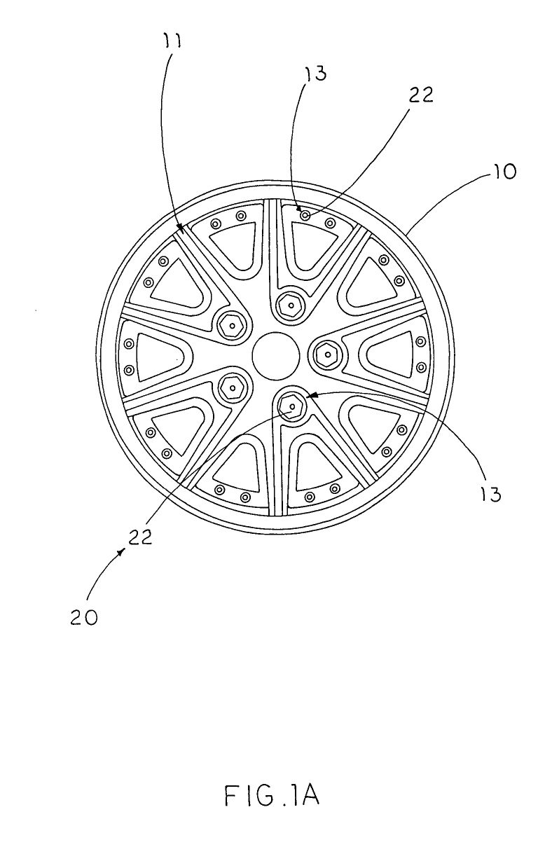

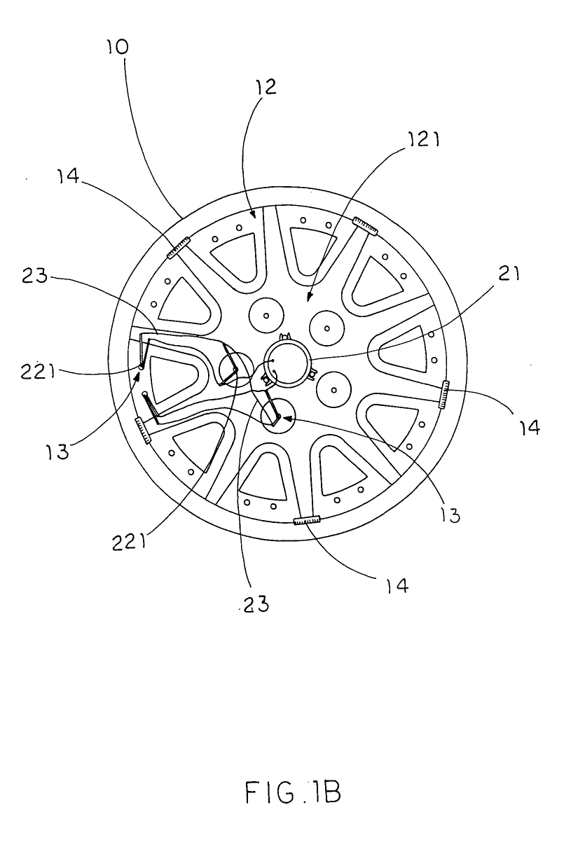

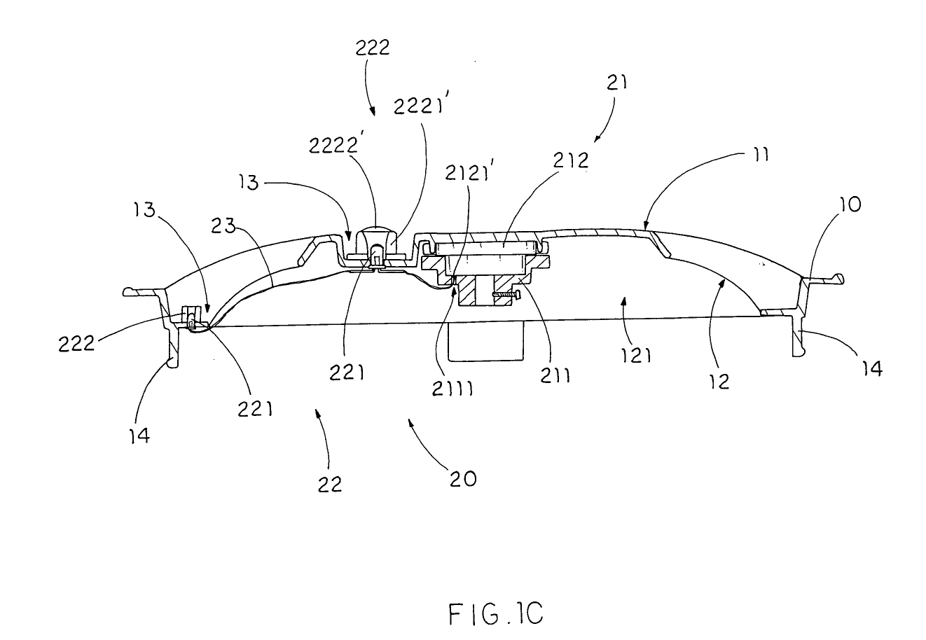

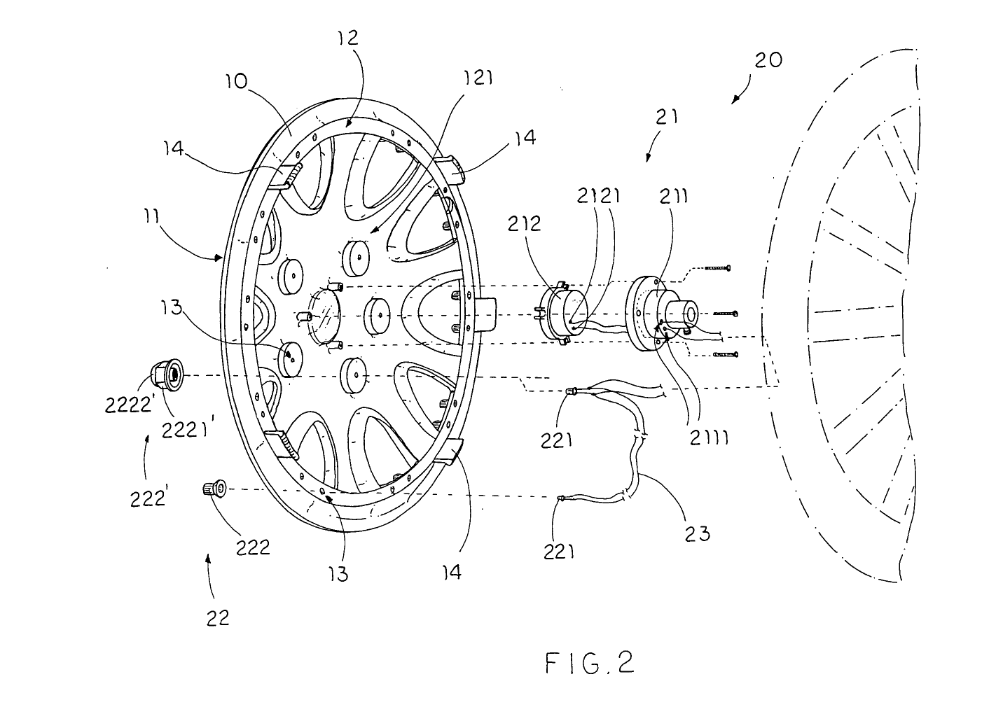

Referring to FIGS. 1A to 1C and 2 of the drawings, a wheel cover adapted for mounting on a wheel according to a preferred embodiment of the present invention is illustrated, wherein the wheel cover comprises a cover body 10 and a self generating light arrangement 20.

The cover body 10 has an outer side 11, an opposed inner side 12 defining a receiving cavity 121, at least a holding slot 13 formed on the cover body 10 to communicate the outer side 11 with the inner side 12, and a plurality of attaching arms 14 extended from the inner side 12 of the cover body 10 for detachably attaching the cover body 10 on the wheel.

The self generating light arrangement 20 comprises a power generating unit 21 coaxially mounted on the inner side 12 of the cover body 10 within the receiving cavity 121, wherein the power generating unit 21 is adapted for self-generating electricity by means of induction when the cover body 10 is rotated with respect to the wheel, and at least an illuminating unit 22, which is electrically connected with the power generating unit 21, securely mounted at the holding slot 13 of the cover body 10 in such a manner that when the cover body 10 is driven to rotate, the illuminating unit 21 is activated for providing a light effect.

According to the preferred embodiment, the cover body 10, which is preferably made of plastic material or the like, has a predetermined size with respect to the size of the wheel so as to fittingly cover the cover body 10 on the wheel.

As shown in FIG. 1B, the attaching arms 14 are integrally and outwardly extended from the inner side 12 of the cover body 10 at an edge portion thereof for detachably attaching on the wheel so as to securely and coaxially mount the cover body 10 on the wheel, wherein the receiving cavity 121 is defined between the inner side 12 of the cover body 10 and the wheel when the cover body 10 is mounted on the wheel. In other words, the wheel cover 10 is driven to be rotated by the rotational movement of the wheel. It is worth to mention that the attaching arms 14 can be any conventional attaching means to mount the cover body 10 on the wheel.

The power generating unit 21 comprises a protective shelter 211 mounted at a center of the inner side 12 of the cover body 10 and a power generator 212 disposed in the protective shelter 211 for generating electricity. The protective shelter 211 is securely mounted at the center of the cover body 10 to retain the power generator 212 in position. The protective shelter 211 is capable of protecting the power generator 212 from any mechanical damage and any environmental particles, such as water, sand, or dirt, effectively. In addition, the protective shelter 211 is adapted to act as a waterproof body for the power generator 212.

Accordingly, the power generator 212, which is embodied as a self motivational electric generator adapted to be automatically switched on to produce electricity through the rotational kinetic force when the cover body 10 is rotated, comprises an electrical circuitry, such as an IC board, manipulating the current and potential of the electricity to provide a stable electric power to the illuminating unit 22.

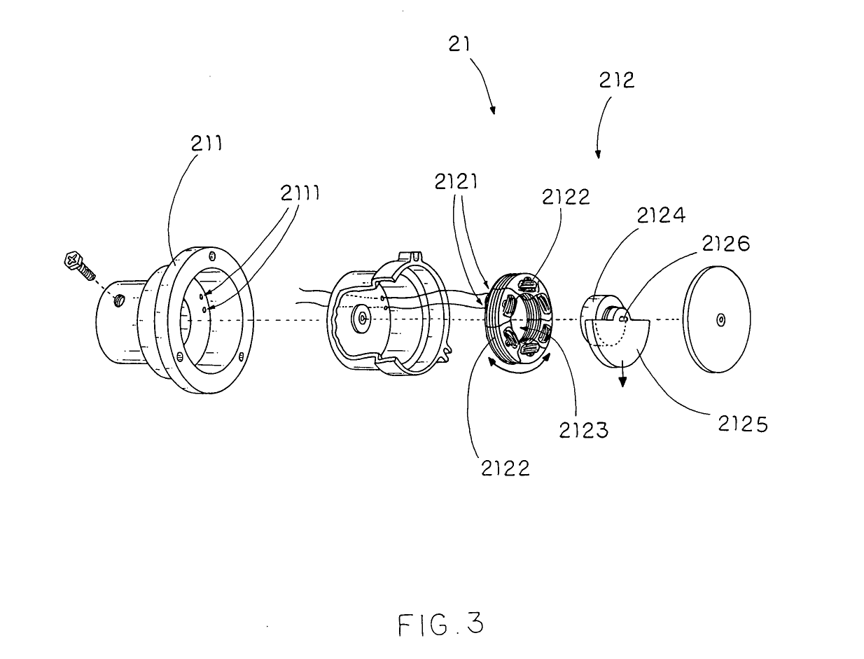

As shown in FIG. 3, the power generator 212 comprises a plurality of induction units 2122 positioned in a radial manner to define an induction cavity 2123 therewithin, a magnet 2124 rotatably disposed within the induction cavity 2123 to communicate with the induction units 2122, such that the cover body 10 is driven to rotate to provide a relatively rotational movement between the induction units 2122 and the magnet 2124 for generating electricity by means of induction.

The power generator 212 further comprises a retaining member 2125 attached to the magnet 2124 to retain the magnet 2124 within the induction cavity 2123 in a stationary manner such that during rotating the cover body 11, the induction units 2122 are driven to coaxially rotate with respect to the magnet 2124 for generating electricity.

Accordingly, the induction units 2122 are radially mounted on the inner side 12 of the cover body 10 such that when the cover body 10 rotates, the induction units 2122 are driven to rotate around the magnet 2124 so as to generate a rotational force towards the magnet 2124. Each of the induction units 2122 comprises a conducting element and an induction coils coiling around the conducting element for generating an induced current via the magnetic field.

The retaining member 2125, having a semi circular shaped, is affixed to a center of the magnet 2124 via a supporting shaft 2126 wherein the retaining member 2125 has a predetermined weight to apply a gravity force on the magnet 2124 to hold the magnet 2124 in a stationary manner within the induction cavity 2123 during rotating the induction units 2122. Therefore, the induced current is produced when the rotational force of the induction units 2122 is applied on the magnetic field of the magnet 2124.

Therefore, when the power generator 212 is driven to rotate via the wheel cover 10, the power generator 212 will generate electricity for the illuminating unit 22. In other words, the power generator 212 is adapted for generating electricity when the power generator 212 is under motion, such as spinning or rotational motion of the wheel cover 10 with respect to the wheel, the electricity will be generated by conversing the kinetic energy to electric energy, which is capable of transforming into other energy such as light or sound energy.

As shown in FIG. 2, the illuminating unit 22 comprises an illuminator 221, which is embodied as a light emitting diode (LED), is securely received in the holding slot 13 of the cover body 10, wherein the illuminator 221 has a head portion protruded from the outer side 11 of the cover body 10 in such a manner that when the illuminator 221 is activated by the power generating unit 21, the illuminator 221 is capable of producing the light effect at the outer side 11 of the cover body 10. Accordingly, the illuminator 221 may be a bulb, a fluorescent lamp or the like, wherein the shape of illuminator 221 may be elongated, spherical, oval, cubical, rectangular or any predetermined shape which is capable of being electricity connected to the power generating unit 21 and positioned on the cover body 10. Accordingly, the light effect can be any color or lighting pattern produced by the illuminator 221.

The illuminating unit 22 further comprises a reflective housing 222 mounted on the outer side 11 of the cover body 10 at the holding slot 13 thereof to align with the illuminator 221 wherein the reflective housing 222 is adapted for reflecting the light from the illuminator 221 so as to enhance the light intensity thereof. As shown in FIG. 2, the reflective housing 222 is embodied as a cog-like hollow member made of transparent material such as plastic, wherein the head portion of the illuminator 221 is coaxially received in the reflective housing 222.

Alternatively, the reflective housing 222′ is embodied to have a semi-spherical reflective cell 2221′ having an inner reflective surface mounted on the outer side 11 of the cover body 10 at the holding slot 13 thereof and a transparent lens 2222′ mounted on the reflective cell 2221′ wherein the head portion of the illuminator 221 is positioned at the focus point of the reflective cell 2221′ such that the light from the illuminator 221 is reflected on the inner reflective surface of the reflective cell 222′ to pass through the transparent lens 2222′ to outside. Accordingly, a reflective coating of a reflecting material such as chromium may be used to apply on the reflective cell 2221′ to form the inner reflective surface thereof. It is worth to mention that the illuminator 221 is received in the reflective housing 222′ such that the reflective housing 222′ serves as a protective shelter to prevent any particles such as water or dust sticking on the illuminator 221.

In order to electrically connect the power generating unit 21 with the illuminating unit 22, the self generating light arrangement 20 further comprises at least two electric wires 23 extended from the power generating unit 21 to the illuminating unit 22. As shown in FIG. 1C, the two electric wires 23 are attached on the inner side 12 of the cover body 10 to electrically connect the power generator 212 with the illuminator 221 through the holding slot 13.

As shown in FIG. 2, the power generator 212 has two terminals 2121, which are positive and negative terminals, electrically connected to the induction units 2122 wherein the two electric wires 23 are electrically mounted to the two terminals 2121 of the power generator 212 respectively. It is worth to mention that in order to protect the power generator 212, the two terminals 2121 of the power generator 212 are enclosed within the protective shelter 211 when the power generator 212 is disposed therewith. The protective shelter 211 further has two guiding grooves 2111 respectively aligned with the two terminals 2121 of the power generator 212 such that the two electric wires 23 are electrically extended from the two terminals 2121 of the power generator 212 to the illuminator 221 through the guiding grooves 2111 thereof.

In view of above, the self generating light arrangement 20 does not require any external power to activate the illuminator 221 such that the cover body 10 is adapted to mount to any vehicle having the wheel, such as car, motorbike, or bicycle, without altering the electrical configuration of the vehicle. In addition, no battery is required such that the user does not need to replace the battery frequently so as to minimize the maintenance cost of the present invention. Once the wheel rotates, the cover body 10 is driven to rotate so as to activate the illuminator 221 for producing the light effect. Therefore, no electric switch or sensor is needed to actuate the illuminator 221 in an on and off manner so as to minimize the manufacturing cost of the present invention. It is worth to mention that the light effect can be served as an alerting signal to indicate the movement of the vehicle, especially for the bicycle.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A wheel cover adapted for mounting on a wheel, comprising:
a cover body having an outer side, an opposed inner side defining a receiving cavity, at least a holding slot formed on said cover body to communicate said outer side with said inner side, and a plurality of attaching arms extended from said inner side of said cover body for detachably attaching said cover body on said wheel; and
a self generating light arrangement, comprising:
a power generating unit comprising a power generator coaxially supported on said inner side of said cover body within said receiving cavity, wherein said power generator comprises a plurality of induction units positioned in a radial manner to define an induction cavity therewithin and a magnet rotatably disposed within said induction cavity such that said cover body is driven to rotate to provide a relatively rotational movement between said induction units and said magnet for self-generating electricity by means of induction when said cover body is rotated with respect to said wheel; and
at least an illuminating unit, which is electrically connected with said power generating unit, securely mounted at said holding slot of said cover body in such a manner that when said cover body is driven to rotate, said illuminating unit is activated for providing a light effect.

2. The wheel cover, as recited in claim 1, wherein said induction units are raidially attached on said inner side of said cover such that when said cover body is driven to rotate, said induction units are rotated around said magnet for generating electricity.

3. The wheel cover, as recited in claim 2, wherein said power generator further comprises a retaining member attached to said magnet for applying a gravity force on said magnet, so as to hold said magnet in a stationary manner within said induction cavity during rotating said induction units.

4. The wheel cover, as recited in claim 2, wherein said power generating unit comprises a protective shelter mounted at a center of said inner side of said cover body to receive said power generator in position, wherein said self generating light arrangement further comprises two electric wires extended from two terminals of said power generator respectively to said illuminating unit on said inner side of said cover body through said protective shelter.

5. The wheel cover, as recited in claim 3, wherein said power generating unit comprises a protective shelter mounted at a center of said inner side of said cover body to receive said power generator in position, wherein said self generating light arrangement further comprises two electric wires extended from two terminals of said power generator respectively to said illuminating unit on said inner side of said cover body through said protective shelter.

6. The wheel cover, as recited in claim 4, wherein said protective shelter further has two guiding grooves respectively aligned with said two terminals of said power generator when said two terminals of said power generator are enclosed within said protective shelter such that said two electric wires are electrically extended from said two terminals of said power generator to said illuminating unit through said two guiding grooves respectively.

7. The wheel cover, as recited in claim 5, wherein said protective shelter further has two guiding grooves respectively aligned with said two terminals of said power generator when said two terminals of said power generator are enclosed within said protective shelter such that said two electric wires are electrically extended from said two terminals of said power generator to said illuminating unit through said two guiding grooves respectively.

8. The wheel cover, as recited in claim 1, wherein said illuminating unit comprises an illuminator securely received in said holding slot of said cover body, wherein said illuminator has a head portion protruded from said outer side of said cover body in such a manner that when said illuminator is activated by said power generating unit, said illuminator is capable of producing said light effect at said outer side of said cover body.

9. The wheel cover, as recited in claim 3, wherein said illuminating unit comprises an illuminator securely received in said holding slot of said cover body, wherein said illuminator has a head portion protruded from said outer side of said cover body in such a manner that when said illuminator is activated by said power generating unit, said illuminator is capable of producing said light effect at said outer side of said cover body.

10. The wheel cover, as recited in claim 7, wherein said illuminating unit comprises an illuminator securely received in said holding slot of said cover body, wherein said illuminator has a head portion protruded from said outer side of said cover body in such a manner that when said illuminator is activated by said power generating unit, said illuminator is capable of producing said light effect at said outer side of said cover body.

11. The wheel cover, as recited in claim 8, wherein said illuminator is a LED having a head portion protruded from said outer side of said cover body.

12. The wheel cover, as recited in claim 9, wherein said illuminator is a LED having a head portion protruded from said outer side of said cover body.

13. The wheel cover, as recited in claim 10, wherein said illuminator is a LED having a head portion protruded from said outer side of said cover body.

14. The wheel cover, as recited in claim 8, wherein said illuminating unit further comprises a reflective housing mounted on said outer side of said cover body at said holding slot thereof to align with said illuminator for reflecting a light from said illuminator.

15. The wheel cover, as recited in claim 10, wherein said illuminating unit further comprises a reflective housing mounted on said outer side of said cover body at said holding slot thereof to align with said illuminator for reflecting a light from said illuminator.

16. The wheel cover, as recited in claim 11, wherein said illuminating unit further comprises a reflective housing mounted on said outer side of said cover body at said holding slot thereof to align with said illuminator for reflecting a light from said illuminator.

17. The wheel cover, as recited in claim 13, wherein said illuminating unit further comprises a reflective housing mounted on said outer side of said cover body at said holding slot thereof to align with said illuminator for reflecting a light from said illuminator.

18. The wheel cover, as recited in claim 14, wherein said reflective housing comprises a semi-spherical reflective cell, having an inner reflective surface, mounted on said outer side of said cover body at said holding slot thereof and a transparent lens mounted on said reflective cell, wherein said illuminator is positioned at a focus point of said reflective cell such that said inner reflective surface of said reflective cell is adapted for reflecting said light from said illuminator to outside through said transparent lens.

19. The wheel cover, as recited in claim 15, wherein said reflective housing comprises a semi-spherical reflective cell, having an inner reflective surface, mounted on said outer side of said cover body at said holding slot thereof and a transparent lens mounted on said reflective cell, wherein said illuminator is positioned at a focus point of said reflective cell such that said inner reflective surface of said reflective cell is adapted for reflecting said light from said illuminator to outside through said transparent lens.

20. The wheel cover, as recited in claim 16, wherein said reflective housing comprises a semi-spherical reflective cell, having an inner reflective surface, mounted on said outer side of said cover body at said holding slot thereof and a transparent lens mounted on said reflective cell, wherein said illuminator is positioned at a focus point of said reflective cell such that said inner reflective surface of said reflective cell is adapted for reflecting said light from said illuminator to outside through said transparent lens.

21. The wheel cover, as recited in claim 17, wherein said reflective housing comprises a semi-spherical reflective cell, having an inner reflective surface, mounted on said outer side of said cover body at said holding slot thereof and a transparent lens mounted on said reflective cell, wherein said illuminator is positioned at a focus point of said reflective cell such that said inner reflective surface of said reflective cell is adapted for reflecting said light from said illuminator to outside through said transparent lens.
